(19) United States
(12) Patent Application Publication
(10) Pub. No.: US 2004/0153780 A1
(43) Pub. Date: Aug. 5, 2004

(54) Method and device for the correction of the dynamic error of a sensor

(76) Inventors: Manfred Strohrmann, Karlsruhe (DE); Uwe Konzelmann, Asperg (DE)

Correspondence Address: Striker Striker & Stenby, 103 East Neck Road, Huntington, NY, 11743, US

(21) Appl. No.: 10/481,561

(22) PCT Filed: Jul. 5, 2002
(86) PCT No.: PCT/DE02/02465

(30) Foreign Application Priority Data
Jul. 11, 2001 (DE) 101 33 524.5

(51) Int. Cl. H04B 1/74

(52) U.S. Cl. 714/25

(57) ABSTRACT

A method and device for the correction of the dynamic error of a sensor are disclosed. The sensor output signal is fed to a filter circuit and a correction circuit to carry out said correction. The correction circuit is supplied with one or several filtered signals from the filter circuit and generates a corrected sensor signal from information derived thereby from a comparison of the filtered signals with the unfiltered sensor output signal, or a corrected signal derived therefrom, which is supplied to a further processing.

The present invention relates to a method for the correction of the dynamic error of a sensor, in particular of an air-mass meter having a characteristic curve with a sharp, non-linear bend and response delay, having the features of claim 1, and a circuit arrangement for carrying out this method.

### BACKGROUND INFORMATION

Sensors having a characteristic curve with a sharp, non-linear bend, such as air-mass sensors, for example, function satisfactorily in steady-state operation, in which the physical variable it is designed to detect changes slowly, and no higher-frequency fluctuations—except for a certain noise—are superposed on this change, because the comparatively high-frequency noise can be easily filtered out.

Dynamic operation is given when an air-mass sensor is used in the intake manifold of an internal combustion engine, however, because the intake-air mass fluctuates with the power cycle of the internal combustion engine. Periodic fluctuations having a frequency and amplitude that change continuously with engine speed are therefore superposed on the “ideal” sensor signal, which changes comparatively slowly and represents the air mass that is actually flowing through the intake manifold per unit of time. Particularly high amplitudes occur, in particular, when resonance phenomena occur. Moreover, aperiodic dynamic events with highly divergent amplitudes can occur, such as a jump in air mass during acceleration.

In dynamic operation of this type, sensors having a characteristic curve with a sharp, non-linear bend exhibit a dynamic error that depends on the inertia of the sensor element, among other things. In addition, the additional filtering of the signal from the sensor can result in a measurement error.

With engine management systems that are common today, the output signal from air-mass meters—which fluctuates rapidly due to periodic and aperiodic superpositions—is sampled in millisecond cycles, and the particular detected measured values are corrected using correction values that are taken from correction value tables stored in read-only memory with reference to instantaneously measured speed and throttle-valve position values. The disadvantage of this is that a comparatively high outlay for circuit technology is required due not only to the rapid sampling of the sensor output signal, but, in particular, to obtain and process two further measured values (speed and throttle-valve angle).

In contrast, the object of the invention is to provide a method and a circuit arrangement for carrying out this method, with which a reliable dampening of the interferences superposed on the signal is achieved, even when the sensor output signal fluctuates greatly.

### Presentation and Explanation of the Invention

The object of the invention is attained by the features described in claim 1 (method) and claim 2 (circuit arrangement).

These inventive measures are based on the knowledge that, when the sensor output signal is filtered, e.g., with a linear filter of the first order, a different mean results in dynamic operation depending on the time constant of the filter, while no differences occur during steady-state operation. This means that, by comparing the unfiltered sensor output signal and/or a pre-corrected signal derived therefrom with a signal derived from the sensor output signal by filtering, information regarding the size of the dynamic error present at that time can be obtained, and it can be used to correct the sensor output signal.

A circuit arrangement according to the invention for the correction of the dynamic error of sensors having a characteristic curve with a sharp, non-linear bend therefore includes at least one and preferably several filter stages to which the faulty sensor output signal is supplied in parallel, and that have different pass-through characteristics. Furthermore, a correction circuit is provided that has a number of correction stages that is equal to the number of filter stages, which said correction stages are connected in series in such a manner that the faulty sensor output signal is fed to the first correction stage, and the corrected output signal from the preceding correction stage is fed to each successive correction stage.

Furthermore, each correction stage has a second signal input, at which the filter output signal from the associated filter stage is located. Since the pass-through characteristics of the individual filter stages differ from each other, each of these filter output signals contains different information about the difference between the “ideal” sensor output signal and the actual sensor output signal.

This information is determined in the particular correction stage by comparing its two input signals, and it is used to correct the signal located at its first signal input. In this manner, a continually progressive correction of the faulty sensor output signal takes place from correction stage to correction stage, so that the last correction stage outputs a sensor signal that has been corrected with corresponding thoroughness. The number of correction stages employed depends on the requirements regarding the accuracy with which the corrected sensor signal output by the last correction stage should conform with the “ideal” sensor signal.

Preferably, the two input signals of each correction stage are compared via subtraction, and a correction signal is preferably generated by multiplying the differential signal obtained in this manner by a constant factor that was determined for each correction stage with associated filter stage via calibration measurement and that is stored permanently in the correction stage. The corrected output signal of the correction stages is then generated preferably by adding the corrected signal in the first correction stage in the series circuit to the sensor output signal and, in each subsequent correction stage, to the corrected output signal from the preceding correction stage.

According to a particularly preferred embodiment, the filter stages are low-pass filters that differ from each other in terms of their edge frequencies.

Independent of the particular filter characteristic curves used, it is essential that the output signals from the filters with less sharp filter conditions are fed to the stages located closer to the entry in the series circuit of the correction stages, and those from the filters with the sharper filter conditions are fed to the filter stages located closer to the end of the series circuit.

### Advantages of the Invention

The particular advantages of the invention are that it can be realized using comparatively simple circuits, it does not require determination of any additional measured values—beyond one-time calibration measurements—such as speed or throttle-valve angle, yet it still enables a correction of the faulty sensor output signal that meets high requirements. Jumps in the “ideal” sensor output signal, such as those that occur during sudden acceleration, are depicted in correct fashion in the corrected sensor signal.

These and further advantages of the invention are obtained with the aid of the features described in the subclaims.

### DRAWING

FIG. 1 is a very general block diagram for explanation of the basic principle of the invention.

FIG. 2 is a schematic block diagram of a preferred embodiment in greater detail.

### DETAILED DESCRIPTION OF THE EMBODIMENTS

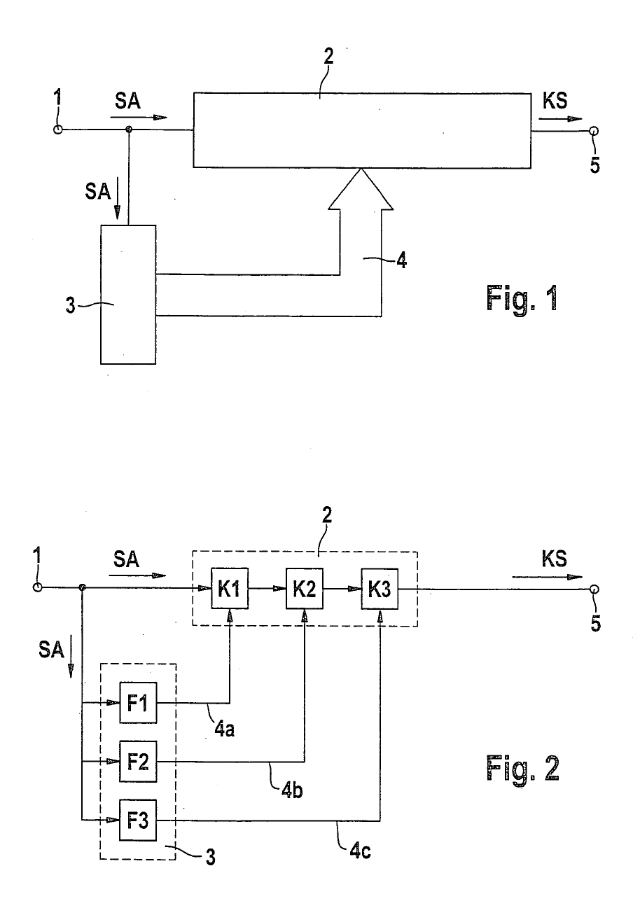

FIG. 1 shows a general exemplary embodiment of the invention as a highly schematized block diagram, whereby the sensor, the dynamic error of which is to be corrected, is not shown.

This sensor can be an air-mass meter, for example, that has a characteristic curve with a sharp, non-linear bend as well as a certain response delay. As long as the physical variable to be detected by such a sensor—i.e., in the case of an air-mass meter, the air mass flowing through the intake manifold per unit of time—varies slowly, the sensor emits a sensor signal SA that changes correspondingly slowly. Due to the pulsating intake of the downstream internal combustion engine, a periodic signal is superposed on said sensor signal, the frequency of which said periodic signal depends, in general, on the number of cylinders in the engine and which changes with engine speed.

In many operating states, the amplitude of the periodic superposed signal is so low that one-fold filtering suffices to calculate the mean in order to obtain a sufficiently accurate, corrected sensor signal. If, however, the amplitude of the superposed signal takes on high values due to resonances, in particular, sensor output signal SA is tainted with an unacceptable dynamic error due to the non-linearity of the sensor characteristic line and the delayed response behavior of the sensor.

To correct this, according to the invention, sensor output signal SA is applied to an entry connection 1 of the circuit arrangement according to the invention, from where it arrives at a first signal input of a correction circuit 2 and an input of a filter circuit 3. The information obtained in filter circuit 3 by filtering sensor output signal SA is forwarded via a connector 4 to correction circuit 2, which corrects sensor output signal SA using this information and outputs a corrected sensor signal KS at output 5 of the circuit arrangement, which said corrected sensor signal can then be supplied to a further processing and evaluation.

Since the above-mentioned occurrence of a dynamic error of real sensor output signal SA corresponds to a distortion of the ideal sensor signal by a filter, information can be obtained by sharper filtering of the distorted sensor output signal SA once more in filter circuit 3, which the aid of which said information correction circuit 2 can correct the distorted sensor output signal SA forwarded to it and output a corrected sensor signal KS that corresponds to the ideal sensor signal substantially better than real sensor signal SA.

The basic configuration of a circuit arrangement according to the invention shown in FIG. 1 is depicted in greater detail in FIG. 2 for a concrete exemplary embodiment in somewhat more detailed form. The same reference numerals are used for identical elements as in FIG. 1.

As one can see, filter circuit 3 in this case includes three filter stages F1, F2 and F3, to which real sensor output signal SA is supplied in parallel. Each of the three filter stages is a low-pass filter that differ from each other in terms of their edge frequencies. Filter F1 has the highest edge frequency, so it only suppresses very high superposed frequencies, while filters F2 and F3 have lower edge frequencies, so that filter F2 is passable only by a frequency range that is markedly below that of filter F1. Filter F3 has a pass range that is even lower.

Correction circuit 2 has a number of correction stages K1, K2, K3 that is equal to the number of filter stages in filter circuit 3, which said correction stages are arranged in series in such a manner that the faulty sensor output signal SA supplied to correction circuit 2 is located at a first input of the first correction stage K1, the output of which is joined with the first input of the second correction stage K2, which delivers its output signal to the first input of the third correction stage K3, the output of which coincides with that of correction circuit 2 and outputs the corrected sensor signal KS.

As one can further see in FIG. 2, the output signal of filter F1 with the largest pass range is supplied to the second signal input of first correction stage K1 via line 4a, while the filtered signals from filter stages F2 and F2 are each fed to the second signal input of correction stages K2 and K3, respectively.

Each of the three correction stages K1, K2 and K3 has a not-shown comparator circuit that, for example, calculates the difference between the signals located at the two signal inputs of the correction stage, i.e., in the case of correction stage K1, it calculates the difference between faulty sensor output signal SA and the filtered signal coming from filter stage F1 and, in the case of the two other correction stages K2 and K3, it calculates the difference between the corrected output signal from the particular correction stage immediately preceding it and the filter output signal delivered by the associated filter stage F2 or F3. Furthermore, each of the correction stages K1, K2 and K3 has a not-shown weighting circuit that, for instance, multiplies the differential signal generated by the comparator circuit by a predetermined factor and thereby generates a correction signal, with the aid of which faulty sensor output signal SA and/or the corrected output signals coming from the particular preceding correction stage K1 and K2 (the latter, one additional time) are corrected by adding this correction signal to it.

A progressive and increasingly more accurate correction of faulty sensor output signal SA therefore takes place from correction stage to correction stage in such a manner that filter information is used in each downstream correction stage that is delivered by a low-pass filter with an even narrower pass range.

If the amplitude of the periodic signal with variable frequency superposed on sensor output signal SA is low, the circuit arrangement according to the invention changes sensor output signal SA only slightly, so that corrected sensor signal KS output by it is nearly identical to the first one.

If the amplitudes of the superposed periodic signal are very great, the arrangement according to the invention is utilized in a manner, however, that corrected sensor signal KS output by it corresponds to the ideal sensor output signal substantially better than faulty sensor output signal SA.

The quality of the correction or bringing KS closer to the ideal sensor output signal depends on the number of correction and filter stages used. In applications in which no particularly high requirements are placed on the quality of the correction, a single correction stage and a single filter stage can suffice.

In addition to the subtraction, multiplication by a constant factor and subsequent addition carried out in the correction stages of the exemplary embodiment, other correction operations can be carried out as well that can differ from correction stage to correction stage in particular as well.

Which of the operations produces optimal results depends on the actual application and can be determined in simple fashion using calibration measurements in which the air mass flowing over the air-mass sensor is measured with the aid of a further, highly accurate measurement device, for example, and an attempt is made using different numbers of filter and correction stages with different correction operations to bring corrected sensor signal KS at output 5 of correction circuit 2 as close as possible to the ideal sensor signal determined by the further measurement device.

The constant factors mentioned hereinabove, by which the particular differential signal is multiplied in the various correction stages, can also be determined in this manner.

It is not absolutely necessary to configure filter stages F1, F2 and F3 as low-pass filters. Rather, a satisfactory correction of the dynamic error can also be achieved using filters having other pass-through characteristic curves. It is not necessary for all filter stages used to have the same type of characteristic curves. Instead, low-pass, high-pass and band-pass filters can be combined with each other.

The only essential point is that the filtering be increasingly sharper, and that the information obtained from the sharper filters be fed to the correction stages located further down the series circuit.

What is claimed is:

1. A method for the correction of the dynamic error of a sensor, in particular of an air-mass meter,
wherein the sensor output signal is fed to a filter circuit and a correction circuit, and
wherein the correction circuit generates a corrected sensor signal based on information supplied by the filter circuit, which is supplied to further processing.

2. A device for carrying out the method as recited in claim 1,
wherein the filter circuit has at least one filter stage, and the correction circuit has at least one correction stage,
wherein the sensor output signal is applied at the input of the filter stage and at a first input of the correction stage,
whereby the correction stage has a second input at which the output signal of the filter stage is applied, and
wherein the output of the correction stage at which a corrected output signal occurs is connected to a signal path that leads to the output of the correction circuit that outputs the corrected sensor signal.

3. The device as recited in claim 2,
wherein the filter circuit has at least one further filter stage, and the correction circuit has a number of further correction stages that is equal to the number of further filter stages,
wherein the sensor output signal is applied in parallel to the inputs of the filter stages, and
wherein the correction stages are connected in series in such a manner that the corrected output signal from the particular preceding correction stage is supplied to first input of the next downstream correction stage, while the output signal of the associated filter stage is fed to the particular second input, whereby the corrected sensor output signal occurs at the output of the last of the correction stages that are connected in series.

4. The device as recited in claim 2 or 3,
wherein at least one of the correction stages has a comparator circuit for comparing the two input signals of the correction stage, and a weighting circuit that weights the output signal of the comparator circuit and thereby generates a corrected signal that is used to generate the corrected output signal of the correction stage from the signal occurring at the first input of the correction stage.

5. The device as recited in claim 4,
wherein the comparator circuit calculates the difference between the two input signals of the correction stage.

6. The device as recited in claim 4 or 5,
wherein the weighting circuit for generating the corrected signal multiplies the output signal of the comparator circuit by a predetermined, constant value.

7. The device as recited in one of the claims 4 through 6,
wherein the correction stage has an adding circuit that adds the corrected signal to the signal occurring at the first input of the correction stage to generate the corrected output signal.

8. The device as recited in one of the claims 2 through 7, wherein at least one of the filter stages is a low-pass filter.

9. The device as recited in claim 8,
wherein all filter stages are low-pass filters having different edge frequencies, and wherein the output signal of the filter stage having the highest edge frequency is supplied to the first correction stage in the series circuit, the output signal of the filter stage having the second-highest edge frequency is supplied to the second correction stage in the series circuit, etc.

10. The device according to one of the claims 4 through 9, wherein the weighting of the output signal of the comparator circuit takes place in the correction stages, each with a different weighting factor.
